(19) United States
(12) Patent Application Publication
(10) Pub. No.: US 2012/0096445 A1
(43) Pub. Date: Apr. 19, 2012

(54) METHOD AND APPARATUS FOR PROVIDING PORTABILITY OF PARTIALLY ACCELERATED SIGNAL PROCESSING APPLICATIONS

(75) Inventors: Heikki Ilmari Berg, Seinajoki (FI); Harri Hirvola, Espoo (FI); Tommi Juhani Zetterman, Espoo (FI); Kalle August Raiskila, Nukari (FI)

(73) Assignee: Nokia Corporation

(21) Appl. No.: 12/906,639

(22) Filed: Oct. 18, 2010

(51) Int. Cl. G06F 9/45

(52) U.S. Cl. 717/140

(57) ABSTRACT

A method for providing portability of partially accelerated signal processing applications may include receiving target information descriptive of accelerated function availability of a target hardware platform, receiving source code for an application and defining functions associated with the application, at least one of the functions being capable of accelerated implementation in the target hardware platform, and causing compiling of an executable code including either an at least partially hardware accelerated implementation or a processor-based implementation based on the target information. A corresponding apparatus and computer program product are also provided.

### TECHNOLOGICAL FIELD

An embodiment of the present invention relates generally to resource management technology and, more particularly, relates to a method and apparatus for providing portability of partially accelerated signal processing applications.

### BACKGROUND

The modern communications era has brought about a tremendous expansion of wireline and wireless networks. Computer networks, television networks, and telephony networks are experiencing an unprecedented technological expansion, fueled by consumer demand. Networking technologies have addressed related consumer demands, while providing more flexibility and immediacy of information transfer.

Current and future networking technologies continue to facilitate ease of information transfer and convenience to users by expanding the capabilities of electronic devices and by improving network performance. One advance that has improved the capabilities of electronic devices to provide services and processing to users is the use of parallel computing. Parallel computing involves either the user of multiple processors or multi-core processors in a single device or multiple processors distributed over different devices to perform computing operations such as calculations, computations or other processing efforts using the parallel resources of the processors involved. Thus, for example, some threads may be processed on one processor or core, while other threads may be simultaneously processed on another processor or core.

Significant increases in speed and processing capabilities may be added to devices or systems that employ parallel computing. Accordingly, in the absence of space, cost and power consumption limitations, it may otherwise be desirable to continue to add additional processors or cores to continue to increase the processing capabilities of devices. However, the limitations described above are very common in real world devices. Moreover, for mobile electronic devices, the limitations tend to be more acute than may be experienced in some other environments.

Accordingly, it may be desirable to manage the computing resources and power resources in parallel computing environments in some cases.

### BRIEF SUMMARY

A method, apparatus and computer program product are therefore provided to enable portability of partially accelerated signal processing applications. In this regard, for example, some embodiments may provide for portability of accelerated or partially accelerated signal processing algorithms by providing an ability to selectively support either hardware accelerated or processor-based implementations dependent upon the target hardware platform that is ultimately to execute code that is being compiled on another platform ahead of time.

In one example embodiment, a method of providing portability of partially accelerated signal processing applications is provided. The method may include receiving target information descriptive of accelerated function availability of a target hardware platform, receiving source code for an application and defining functions associated with the application, at least one of the functions being capable of accelerated implementation in the target hardware platform, and causing compiling of an executable code including either an at least partially hardware accelerated implementation or a processor-based implementation based on the target information.

In another example embodiment, an apparatus for providing portability of partially accelerated signal processing applications is provided. The apparatus may include at least one processor and at least one memory including computer program code. The at least one memory and the computer program code may be configured to, with the at least one processor, cause the apparatus to perform at least receiving target information descriptive of accelerated function availability of a target hardware platform, receiving source code for an application and defining functions associated with the application, at least one of the functions being capable of accelerated implementation in the target hardware platform, and causing compiling of an executable code including either an at least partially hardware accelerated implementation or a processor-based implementation based on the target information.

In one example embodiment, another apparatus for providing portability of partially accelerated signal processing applications is provided. The apparatus may include means for receiving target information descriptive of accelerated function availability of a target hardware platform, means for receiving source code for an application and defining functions associated with the application, at least one of the functions being capable of accelerated implementation in the target hardware platform, and means for causing compiling of an executable code including either an at least partially hardware accelerated implementation or a processor-based implementation based on the target information.

In one example embodiment, a computer program product for providing portability of partially accelerated signal processing applications is provided. The computer program product may include at least one computer-readable storage medium having computer-executable program code instructions stored therein. The computer-executable program code instructions may include program code instructions for receiving target information descriptive of accelerated function availability of a target hardware platform, receiving source code for an application and defining functions associated with the application, at least one of the functions being capable of accelerated implementation in the target hardware platform, and causing compiling of an executable code including either an at least partially hardware accelerated implementation or a processor-based implementation based on the target information.

An example embodiment of the invention may provide a method, apparatus and computer program product for employment in mobile environments or in fixed environments. As a result, for example, mobile terminal and other computing device users may enjoy an improved management of processes in consideration of available power and computing resources.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a wireless communications system according to an example embodiment of the present invention;

FIG. 2 illustrates a block diagram of an apparatus for providing portability of partially accelerated signal processing applications according to an example embodiment of the present invention;

FIG. 3 illustrates a block diagram of a system employing a compiler according to an example embodiment;

FIG. 4 illustrates an example of a static data flow graph according to one embodiment;

FIG. 5 illustrates an architecture of a simulation workstation multi-core processor according to an example embodiment;

FIG. 6 illustrates an architecture for execution of parallel digital signal processor programs according to an example embodiment;

FIG. 7 shows the example architecture of FIG. 6 with the addition of a hardware accelerator according to an example embodiment;

FIG. 8 illustrates a diagram of how an example embodiment may be employed during a design stage according to an example embodiment;

FIG. 9 illustrates how an example embodiment may be used to produce a single software package both for accelerated and non-accelerated targets according to an example embodiment;

FIG. 10 illustrates how an example embodiment may be used to build a software package for a multi-radio software defined radio device according to an example embodiment; and

FIG. 11 is a flowchart according to an example method for providing portability of partially accelerated signal processing applications according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of portability of partially accelerated signal processing applications. Modern portable devices rely heavily on high bandwidth, hard real time signal processing. For example, the multimedia codecs and radio tranceivers of modern smartphones may have requirements for hundreds of giga operations per second with extremely low power consumption. These signal processing applications are sometimes not very tightly coupled to the hardware, but can be considered to process digitized data gathered from antennas or sensors or stored in non-volatile memory. These applications are examples of scientific computing in embedded devices, applying mathematical transformations to the input data. The signal processing applications and parts thereof along with functions implementing the algorithms thereof, may employ a relatively large amount of parallelism. Exploiting parallelism to achieve high processing throughput, rather than high operating frequency, is often the most energy efficient approach. Therefore, it is often considered important to implement the functions in a manner that preserves the parallelism as much as possible in the implementation.

When reprogrammability of signal processing applications is a requirement or is desirable, there are typically only two or three, viable candidates for the implementation. Either the signal processing is implemented with reconfigurable hardware like field programmable gate arrays (FPGAs) or with programmable signal or general-purpose processors. Although an FPGA may provide enough bandwidth for a portable device, power consumption may be too large for some cases. Therefore, programmable general-purpose processors, traditional signal processors, vector processors, programmable customizable processors and programmable graphics processing units (GPU) are sometimes considered to be more viable ways to achieve both the required bandwidth and reprogrammability. However, some algorithms are most naturally implemented as hardware accelerators. Reasons for implementing algorithms as hardware accelerators may include, for example, execution of the algorithm on a programmable processor taking too much time, a hardware based implementation on an application specific integrated circuit (ASIC) being more power efficient, or an ASIC implementation offering more parallelism.

Standard ANSI C does not compile efficiently to parallel processing. C is a sequential imperative language, which means that the statements written in the source code should be executed one after another just as written. If the original algorithm had parallelism, it is completely serialized in the C implementation. For a compiler to effectively produce an executable for a parallel target, the parallelism should be explicitly exposed to it. C implementations hide the parallelism natively present in the algorithm, leaving the compiler the burden of re-discovering it. Additionally, parallelizing C compilers need to be conservative in their efforts of finding parallelism. In a sense, parallelizing C compilers have to prove to themselves that the parallelized code produces the same results as a simple sequential translation of the source code. Unfortunately, due to the reference semantics and multiple assignment semantics of the C language, this is often impossible to prove, except in some limited cases.

For efficient implementation of a signal processing application for a programmable processor, the only option available today is to use the C language augmented with parallelization hints (pragmas), compiler intrinsic functions or assembly. Accordingly, the solution typically has involved delegation of the task of creating and managing parallelism to the programmer. Compiler intrinsics are simple function calls, which translate directly to the instruction set of the target processor. Programming with intrinsics may operate like assembly programming, but with the compiler instead of the programmer performing register allocation and instruction scheduling. The C language may be used to form composite functions and applications. A major problem with intrinsics is their poor portability, due to the close mapping to hardware. The implementation of a function with intrinsics often requires very good and experienced programmers, who may be very hard to find and keep. This problem creates an artificial source code lock to the processor vendor. Additionally, the usage of intrinsincs, if not C alone, renders the original algorithms, typically described as mathematical formulae, unrecognizable in the source code.

Source code porting may not be a problem with simpler applications. However, for large and/or complex physical layers of modern radio protocols or multimedia codecs, scalability, portability and maintainability may become important issues. The portability problem may be especially difficult in software-defined radio and in cognitive radio, as the core idea behind these two concepts is that implementation of a complete radio is programmable and the implementation can be transferred to another target hardware just by compiling the source code. This type of portability may be impossible if the source code is specific to the target hardware.

Some signal processing algorithms are most naturally implemented as hardware accelerators. For example, in radio implementations Turbo encoders and decoders as well as LDPC (low density parity check) encoders and decoders are typically implemented as accelerators due to throughput and/or energy efficiency reasons. Both of these are examples of modern forward error correction codes (FEC). The FECs used in a radio system are part of the radio standard and typically are quite similar between standards, thus the implementations can be shared between radio systems. For similar reasons, parts of a video codec such as H264/AVC are implemented as hardware accelerators.

In programmable processors the number of threads or parallel execution units is typically restricted to a certain number, but there are no limitations for implementations employing ASICs. Similarly, the numerical accuracy of a computation can be more accurately fine tuned, and may not be restricted to the standard 8, 16, 32 or 40 bit fixed-point accuracies available in programmable processors. Ultimately, the choice regarding whether to implement some algorithm as an accelerator or program it for a processor is a system design issue that is based on speed and energy consumption related concerns in radio, video codec and any other signal processing application.

Currently, there is no unified framework for implementing the signal processing algorithms to be executed on programmable processors or as hardware accelerators. The parts of an application which are implemented on a programmable processor are often implemented with ANSI C, C++, or OpenCL (referred to herein jointly as C), possibly augmented with intrinsics or assembly code. The hardware accelerators may be implemented with Verilog, VHDL, SystemC or Catapult-C or the like for FPGAs or ASICs. There is no unified framework for how to connect separate algorithm implementations to a complete signal processing application. As such, the methods are ad-hoc and are different for each and every target hardware platform.

Some embodiments of the present invention may address the portability problem of both the functionality and performance of digital signal processing code by introducing a high-level domain specific language. As the language is a functional data flow programming language, and the typical abstractions and data types of the domain are natively supported or easily presented in the language, the original parallelism of an algorithm may be preserved at the source code level. The dataflow and parallelism may be analyzed by the compiler and appropriately divided into thread, SIMD, and instruction level parallel implementations. Intermediate stages of the compiler may also preserve the parallelism, until the last possible stage, when the parallelism is to be narrowed down to the target architecture. Because the communication and synchronization mechanisms between threads are the responsibility of the compiler, the possibility of human error is drastically reduced. The language is textual and the execution semantics may be defined by giving mapping to synchronous dataflow graphs and data dependency diagrams.

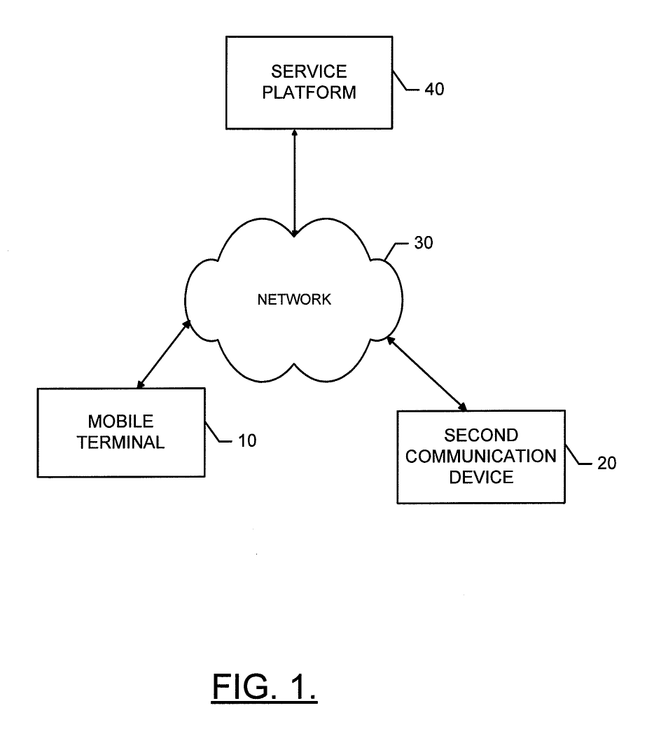

FIG. 1 illustrates a generic system diagram in which a device such as a mobile terminal 10, which may benefit from some embodiments of the present invention, is shown in an example communication environment. As shown in FIG. 1, a system in accordance with an example embodiment of the present invention includes a first communication device (e.g., mobile terminal 10) and a second communication device 20 that may each be capable of communication with a network 30. The second communication device 20 is provided as an example to illustrate potential multiplicity with respect to instances of other devices that may be included in the network 30 and that may practice an example embodiment. The communications devices of the system may be able to communicate with network devices or with each other via the network 30. In some cases, the network devices with which the communication devices of the system communicate may include a service platform 40. In an example embodiment, the mobile terminal 10 (and/or the second communication device 20) is enabled to communicate with the service platform 40 to provide, request and/or receive information.

While an example embodiment of the mobile terminal 10 may be illustrated and hereinafter described for purposes of example, numerous types of mobile terminals, such as portable digital assistants (PDAs), pagers, mobile televisions, mobile telephones, gaming devices, laptop computers, cameras, camera phones, video recorders, audio/video player, radio, GPS devices, navigation devices, or any combination of the aforementioned, and other types of multimedia, voice and text communications systems, may readily employ an example embodiment of the present invention. Furthermore, devices that are not mobile may also readily employ an example embodiment of the present invention. As such, for example, the second communication device 20 may represent an example of a fixed electronic device that may employ an example embodiment. For example, the second communication device 20 may be a personal computer (PC) or other terminal.

In some embodiments, not all systems that employ embodiments of the present invention may comprise all the devices illustrated and/or described herein. For example, while an example embodiment will be described herein in which either a mobile user device (e.g., mobile terminal 10), a fixed user device (e.g., second communication device 20), or a network device (e.g., the service platform 40) may include an apparatus capable of performing some example embodiments in connection with communication with the network 30, it should be appreciated that some embodiments may exclude one or multiple ones of the devices or the network 30 altogether and simply be practiced on a single device (e.g., the mobile terminal 10 or the second communication device 20) in a stand alone mode.

Thus, for example, in embodiments where one or more of the mobile terminal 10, the second communication device 20 and the service platform 40 have multiple processors associated therewith, an example embodiment may be practiced on such a multi-processor device without any communication with the network 30 or with other devices. However, in embodiments where the network 30 is employed, an apparatus located, for example, at the service platform 40 could perhaps manage the power consumption and computing load of the processors of multiple devices (e.g., the mobile terminal 10, the second communication device 20 and the service platform 40) employing an example embodiment of the present invention.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be capable of communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the second communication device 20 via the network 30. By directly or indirectly connecting the mobile terminal 10, the second communication device 20 and other devices to the network 30, the mobile terminal 10 and the second communication device 20 may be enabled to communicate with the other devices (or each other), for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including USB, LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing device. The service platform 40 may have any number of functions or associations with various services. As such, for example, the service platform 40 may be a platform such as a dedicated server (or server bank) associated with a particular information source or service (e.g., a power and/or computing load management service), or the service platform 40 may be a backend server associated with one or more other functions or services. As such, the service platform 40 represents a potential host for a plurality of different services or information sources. In some embodiments, the functionality of the service platform 40 is provided by hardware and/or software components configured to operate in accordance with known techniques for the provision of information to users of communication devices. However, at least some of the functionality provided by the service platform 40 may be information provided in accordance with an example embodiment of the present invention.

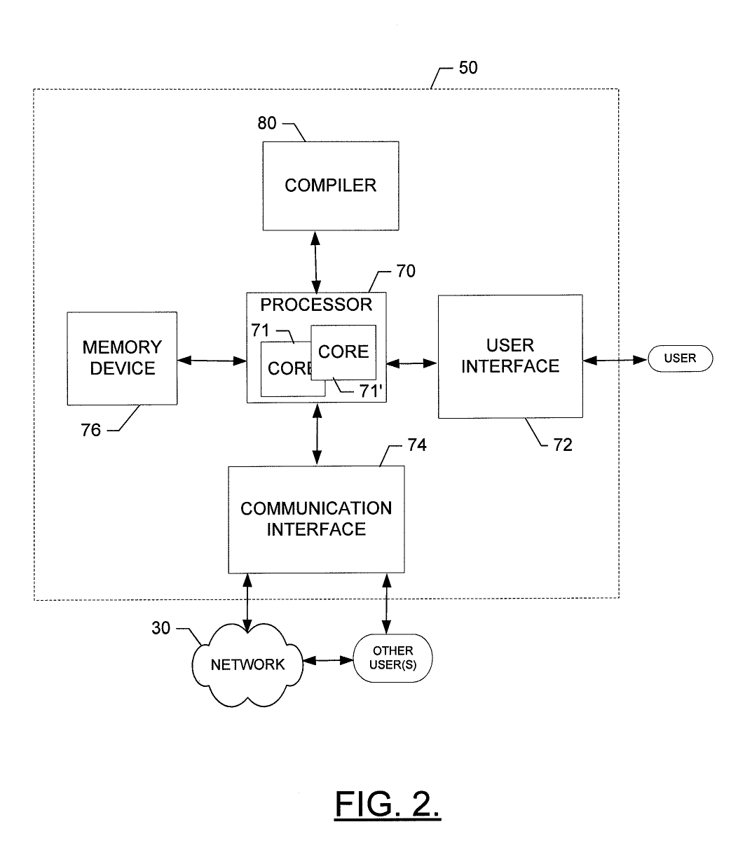

FIG. 2 illustrates a schematic block diagram of an apparatus for providing portability of partially accelerated signal processing applications according to an example embodiment of the present invention. An example embodiment of the invention will now be described with reference to FIG. 2, in which certain elements of an apparatus 50 for providing portability of partially accelerated signal processing applications are displayed. The apparatus 50 of FIG. 2 may be employed, for example, on the service platform 40, on the mobile terminal 10 and/or on the second communication device 20. However, the apparatus 50 may alternatively be embodied at a variety of other devices, both mobile and fixed (such as, for example, any of the devices listed above). In some cases, an embodiment may be employed on either one or a combination of devices. Accordingly, some embodiments of the present invention may be embodied wholly at a single device (e.g., the service platform 40, the mobile terminal 10 or the second communication device 20), by a plurality of devices in a distributed fashion or by devices in a client/server relationship (e.g., the mobile terminal 10 and the service platform 40). Furthermore, it should be noted that the devices or elements described below may not be mandatory and thus some may be omitted in certain embodiments.

Referring now to FIG. 2, an apparatus for providing portability of partially accelerated signal processing applications is provided. The apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), central processing unit (CPU), a hardware accelerator, a vector processor, a graphics processing unit (GPU), a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, or a combination of hardware and software, that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10 or the second communication device 20), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

Although an example embodiment will now be described in the context of a multi-core processor, it should be appreciated that some embodiments may also be practiced in environments where multiple processors are networked together, as described above. In an example embodiment, the processor 70 may be a multi-core processor with two, four, six, eight, or any desirable number of cores. Each of the multiple processor cores (represented by cores 71 and 71′) may represent a portion of the processor 70 that actually reads and executes instructions. Moreover, in an example embodiment, the cores 70 and 71′ (along with other cores if more than two cores are implemented) may execute code or threads in parallel. In this regard, in some cases, parallel libraries may be employed to provide standard implementations and patterns for enabling code to be written in a portable way that can be scaled depending on the number of processors available in a particular environment as described in greater detail below.

In an exemplary embodiment, the processor 70 may be embodied as, include or otherwise control a compiler 80. As such, in some embodiments, the processor 70 may be said to cause, direct or control the execution or occurrence of the various functions attributed to the compiler 80 as described herein. The compiler 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the compiler 80 as described herein. Thus, in examples in which software is employed, a device or circuitry (e.g., the processor 70 in one example) executing the software forms the structure associated with such means. Of note, in some embodiments, the compiler 80 may be embodied as a cross compiler having source code resident in the memory of another processor. In such cases, the processor 70 may execute binary instructions originally stored in the memory associated with the other processor and installed into non-volatile memory of apparatus 50 during program installation time and loaded into processor local memories during program load time.

In an example embodiment, the compiler 80 may generally be configured to provide a mechanism by which to create executables that correspond to a particular application for respective different target hardware. In this regard, the compiler 80 may be configured to utilize high-level functional language that describes a complete signal processing application for providing an automatic interface between system designers and application developers for generation of a portable configuration for use to assemble complete programs from target specific implementations of library components. As such, the compiler 80 may be configured to allow portability by compilation of a signal processing application from single source code between architectures with and without hardware acceleration so that the application uses an available computing platform (including hardware acceleration) efficiently or optimally, including cases where partial acceleration is employed.

In some examples, the compiler 80 may be configured to receive target information descriptive of accelerated function availability of a target hardware platform and also receive source code for an application and defining functions associated with the application. At least one of the functions may be a function that is capable of accelerated implementation in the target hardware platform. The compiler 80 may be further configured to cause compiling of an executable code including either a hardware accelerated implementation or a processor-based implementation based on the target information.

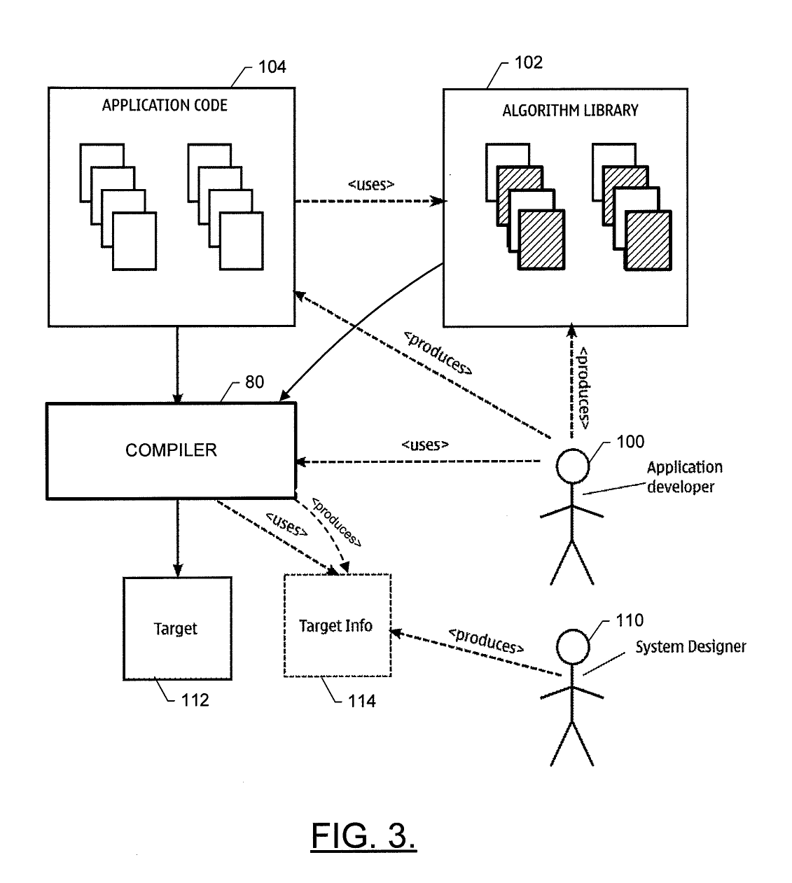

FIG. 3 illustrates a block diagram of a system employing the compiler 80 according to an example embodiment. As shown in FIG. 3, an application developer 100 may produce an algorithm library 102 and application code 104. As such, the application developer 100 may employ a high-level functional language to describe the complete signal processing application corresponding to the application code 104. The application code 104 of FIG. 3 may therefore represent the high-level functional language description of the complete signal processing application. The high-level functional language may be textual and the execution semantics for the high-level functional language may be defined by providing a mapping to synchronous dataflow graphs and data dependency diagrams. All signal processing functions and the interconnections between the functions (e.g., algorithms, kernels, and/or the like) may be described for the application code 104 using the high-level functional language.

The application developer 100 need not necessarily know whether any of the corresponding functions will be realized using hardware accelerators. However, functions that are candidates for acceleration may be provided as source code libraries for the application developer 100. Accordingly, the algorithm library 102 may be provided to describe functions, including functions that are candidates for acceleration, using the same high-level functional language that is used to describe the rest of the application. By using a library-based approach, the interface of the library functions may be fixed and the interface between the system designer 110 and the application developer 100 may be made explicit. Before implementing target hardware 112, it may be possible to promote any algorithm to a library function.

As shown in FIG. 3, the application developer 100 may produce the application code 104 in the high-level functional language and decide which algorithms may be shared between different applications and place those algorithms in the algorithm library 102. The application code 104 may therefore use the corresponding algorithms from the algorithm library 102. The compiler 80 may be configured to be used by the application developer 100 to produce an executable for the target hardware 112 using target information 114 that is provided by the system designer 110.

The system designer 110 may have determined the architecture of the target hardware 112. The system designer 110 may also select the number and type of programmable processors, memory layout and connections of the system, as well as which algorithms from the algorithm library 102 are implemented as accelerators. Selected algorithms are shown in FIG. 3 as being highlighted by crosshatching. The system designer 110 may also use the compiler 80 to produce target information that is usable by the compiler 80 when the application developer 100 compiles the complete program for the target hardware 112.

The system designer 110 may therefore determine which library functions are to be hardware accelerated and compile the selected functions from the algorithm library 102 for hardware accelerator implementation. The compilation may also provide all needed hardware and software interfaces for the accelerated function to be attached to be a part of the complete signal processing application in the target hardware 112. The availability of the accelerated function for the target hardware 112 may then be added to the target machine description for use by the compiler 80.

The input to the compiler 80 may be the source code stored in non-volatile memory of a computer (e.g., stored in the memory device 76 of FIG. 2). The compiler 80 may also receive the target information 114 that is descriptive of the target hardware 112. The target information 114 may include command line parameters or may be a file containing details regarding the capabilities and/or components of the target hardware 112. The target information 114 may inform the compiler 80, among other things, as to which accelerated functions are available in the target hardware 112. As the application developer 100 compiles the complete application for provision to the target hardware 112, the compiler 80 sees a description from the target hardware 112 as to which accelerators are available. The library functions that correspond to available accelerators need not to be compiled from source code. Instead, the accelerators compiled by the system designer 110 may be used. Similarly, if the application uses library functions for which hardware accelerated implementation is not available, the source code of the library function may be compiled to processor-based implementation.

The decision as to whether to accelerate or not, may be made by the system designer 110, rather than by the application developer 100. Additionally, both the software-based and hardware accelerator-based implementations come from the same source code presentation of the algorithm. Accordingly, the complete signal processing application can be developed and tested in a desktop computer or other computing environment to a functionally correct state. Thereafter, the complete signal processing application may be compiled for execution on the target hardware 112. Similarly, the complete signal processing application can be ported from one target hardware to another target hardware just by compilation using the compiler 80. Since the high-level language can present the original parallelism of the signal processing application to the compiler 80, the compiler 80 may be enabled to efficiently utilize the parallel resources available in the target hardware 112 and create an executable binary code, which executes efficiently in the target hardware 112.

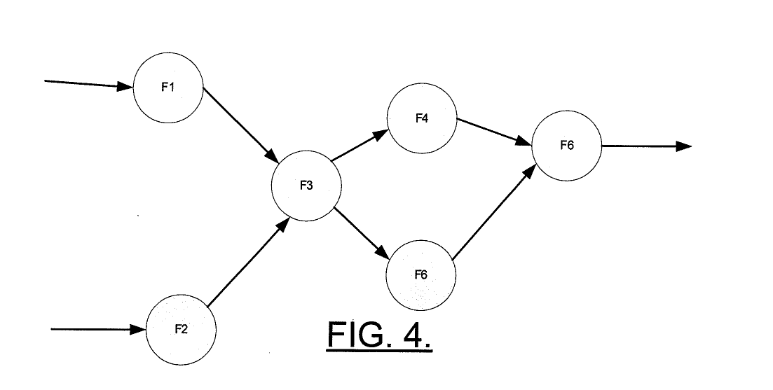

A typical algorithm (e.g., a DSP algorithm) may be represented as a synchronous data flow (SDF) graph including nodes and directed edges. The nodes may represent functional elements performing computation, and the directed edges may represent communication between functional elements. The high-level functional language may be a textual notation to SDF with implicit parallelism. FIG. 4 illustrates an example of an SDF graph of one embodiment. For each node of the SDF (e.g., nodes F1, F2, F3, F4, F5 and F6), the ratio of consumed data (also called “tokens”) arriving to a node's input edges and produced data (e.g., data at output edges) is constant and known at the time of compilation. By providing a constant and known ratio of consumed data to produced data a the time of compilation, compile-time optimization techniques may be employed such as, for example, static memory allocation and scheduling along with efficient parallel implementation of algorithms. Since restrictions associated with SDF graphs are not a major concern in the context of typical algorithms (e.g., DSP algorithms), a high-level functional language that is based on an SDF model may be a suitable way to present an algorithm in some embodiments.

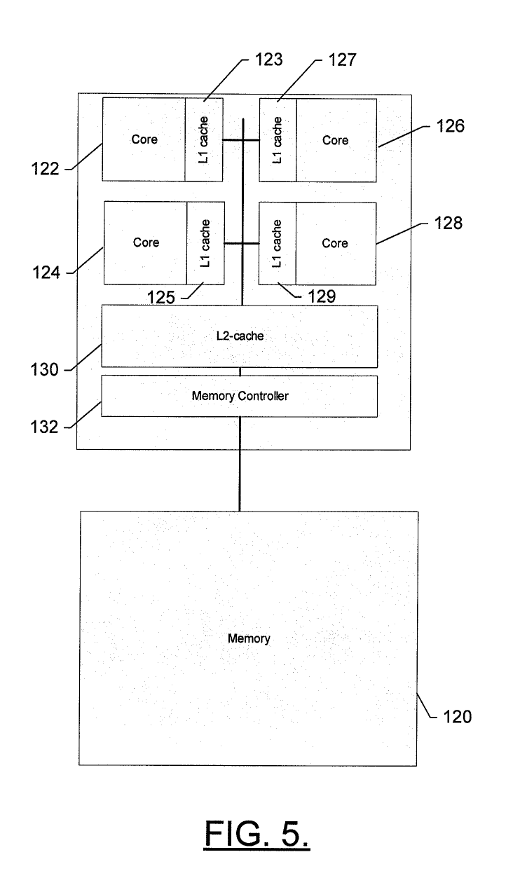

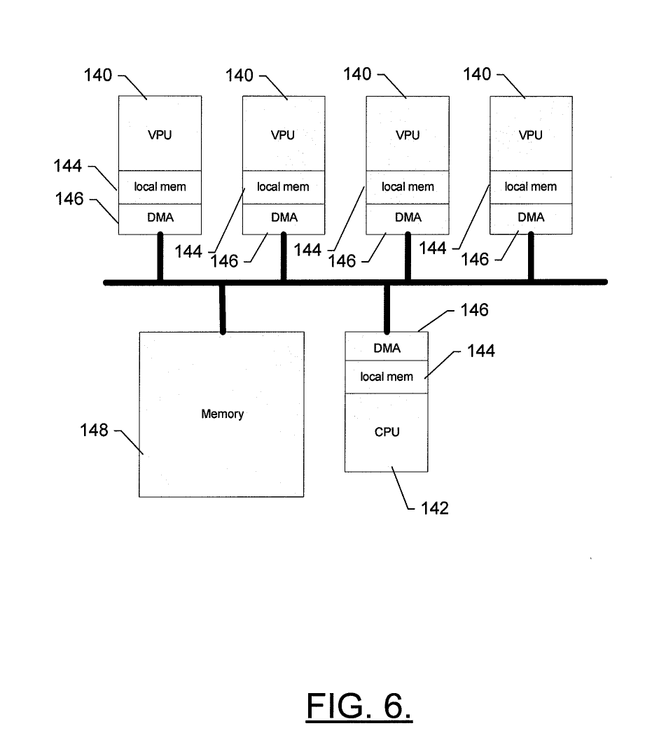

The application developer 100 may employ the compiler 80 for the high-level functional language to produce an executable for the target hardware 112. During the compilation phase, a high-level language presentation of an algorithm may be mapped to the target hardware 112 as described above. A potential advantage of using an SDF language may be that the inherent parallelism algorithm is available in the language description and can be analyzed by the compiler 80 and efficiently targeted to different target architectures. Different target architectures may vary from shared memory machines (like a typical simulation workstation as depicted in FIG. 5) and distributed memory architectures (like a typical embedded software-defined radio modem architecture using embedded vector processors as illustrated in FIG. 6).

FIG. 5 illustrates an example architecture of a simulation workstation multi-core processor. As shown in FIG. 5 a memory 120 may be shared by all of the cores (e.g., cores 122, 124, 126 and 128) of the processor. Each core may have a corresponding L1 cache (e.g., L1 caches 123, 125, 127 and 129) and the processor may have a common L2 cache 130 and a memory controller 132. The shared memory may enable all cores to see the same memory space (e.g., memory 120) and processor hardware may provide a coherent memory view (e.g., cache coherency). FIG. 6 illustrates an example architecture for execution of parallel DSP programs. The platform illustrated may employ a distributed memory architecture (e.g., processing units including vector processing units (VPU) 140 and a central processing unit (CPU) 142 that each have an instance of local memory 144 employing direct memory access (DMA) 146) to enable access to a main memory 148 with a capability for communication with other processing units.

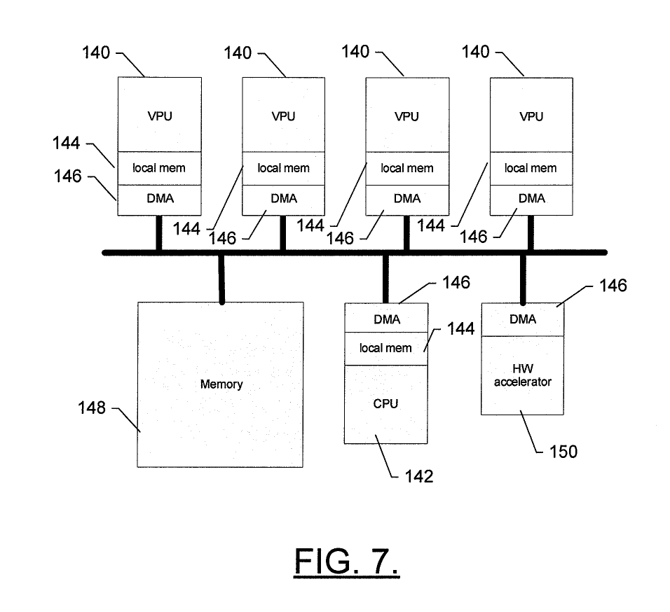

Some target platforms may include special purpose hardware to execute some functions such as, for example, forward error correction (FEC) algorithms. Hardware acceleration may be used when the nature of algorithm is such that it may be faster to execute the algorithm with special hardware, or when the hardware implementation may save power compared to a software alternative. FIG. 7 shows the example architecture of FIG. 6 with the addition of a hardware accelerator 150.

Accordingly, example embodiments of the present invention may enable portability of accelerated (or partially accelerated) signal processing applications by employing the compiler 80. The compiler 80 enables a DSP application developer working with an application to simulate the application and compile an algorithm that is tailored to the target hardware using the workstation or computer of the application developer. The application is described as a high-level language program with implicit parallelism. At this stage a complete high-level language description of the application may be compiled for execution on the workstation. The system designer may determine the architecture of the target hardware and selects the number and type of programmable processors, memory layout and connections of the system as well as which algorithms from a library are to be implemented as accelerators. The compiler 80 may then be used to produce hardware accelerators from the high-level language implementations. Similarly, the compiler 80 may produce target information that the compiler 80 may use when application developer compiles a complete program for the target hardware. When the DSP algorithm is ready, the algorithm may be compiled to the architecture of the target hardware. If the architecture of the target hardware has multiple heterogeneous processing units (PUs) that can compute a logical part of the DSP algorithm (e.g., kernel), that kernel may be compiled to all possible PUs. A hardware accelerator is generally considered as a one type of PU, and compiling a kernel to a hardware accelerator may mean producing a code which configures the HW accelerator correctly, sending input data to it, initiating its execution when the function is called, and receiving results from it. The DSP algorithm delivery package may provide alternative versions of kernels to multiple alternative target processors, vector processors and hardware accelerators. When the DSP algorithm is installed, the correct version of each kernel is selected.

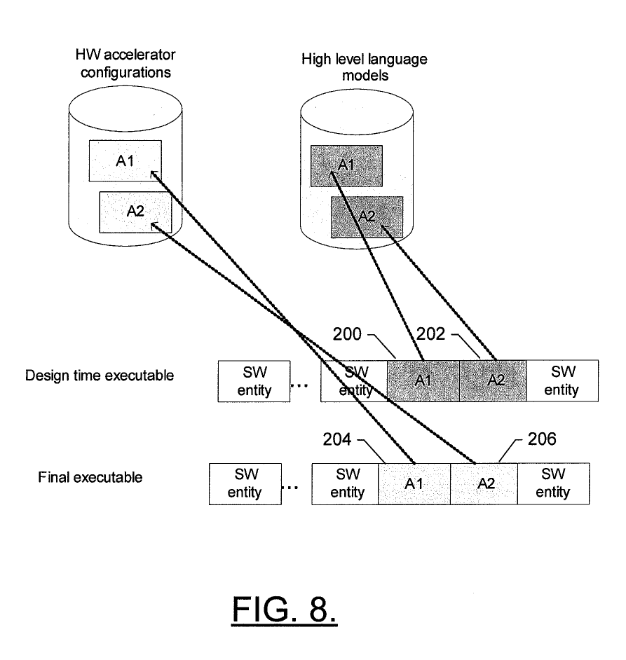

FIG. 8 illustrates a diagram of how an example embodiment may be employed during a design stage. An application developer may compile and execute an application written completely in the same high-level language in a workstation even if the hardware accelerators needed for the designed implementation (and planned for availability in the target hardware) are not available in the workstation. This may be accomplished by using library functions (e.g., from the algorithm library 102) that include the high-level language representations of hardware accelerated functions as source code. Because the interface and source code to these functions is fixed and is also the same as the interface and source code used in hardware accelerated instances, the final program can be linked against a hardware accelerator configurations library to create a final executable. As such, design time executables A1 and A2 (elements 200 and 202, respectively) may be compiled as high-level language models. The compiler 80 may select needed representations of hardware accelerated functions to produce a corresponding hardware accelerated configuration for A1 and A2 (elements 204 and 206, respectively) as the final executable among other non-accelerated functions (e.g., other SW entities).

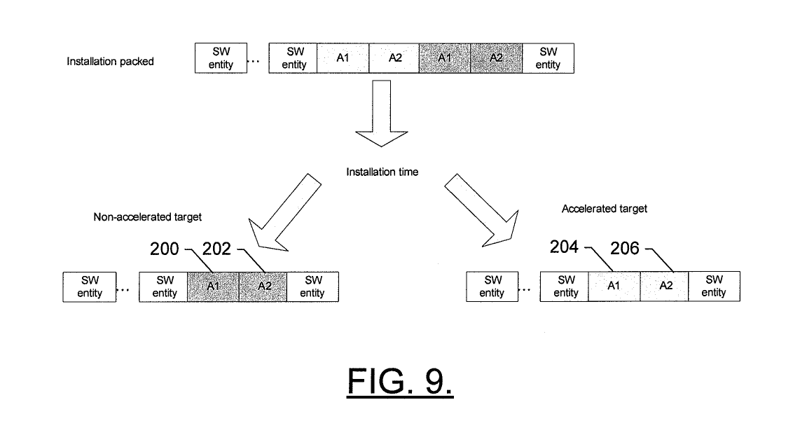

FIG. 9 illustrates how an example embodiment may be used to produce a single software package both for accelerated and non-accelerated targets. In this regard, FIG. 9 shows a logical structure of a software distribution package for both non-accelerated and accelerated targets. As such, FIG. 9 shows a distribution package 250 that is packed initially and includes various functions (e.g., SW entities) along with specific executables A1 and A2 that are designated for use with non-accelerated targets (e.g., elements 200 and 202) and executables A1 and A2 that are designated for use with accelerated targets (e.g., elements 204 and 206). For accelerated functions, the distribution package includes both compiled code for performing the function, and code calling an accelerator that performs the function. At the time of software installation, the installer may pick the accelerated version for each accelerated function target platform provided. Otherwise, software implementation of the function may be used. The installer may select packets based on the platform to be used with a granularity used to divide functionality to hardware accelerators. For example, the installer can pick an accelerated version of one function and a non-accelerated version of another function depending on what accelerators are present in the target platform or hardware. If a target platform uses a different vector processor or signal processor to perform computation, two versions of the software functions (e.g., the software entities) may also be needed. As an alternative, software may be compiled for the target platform at installation time.

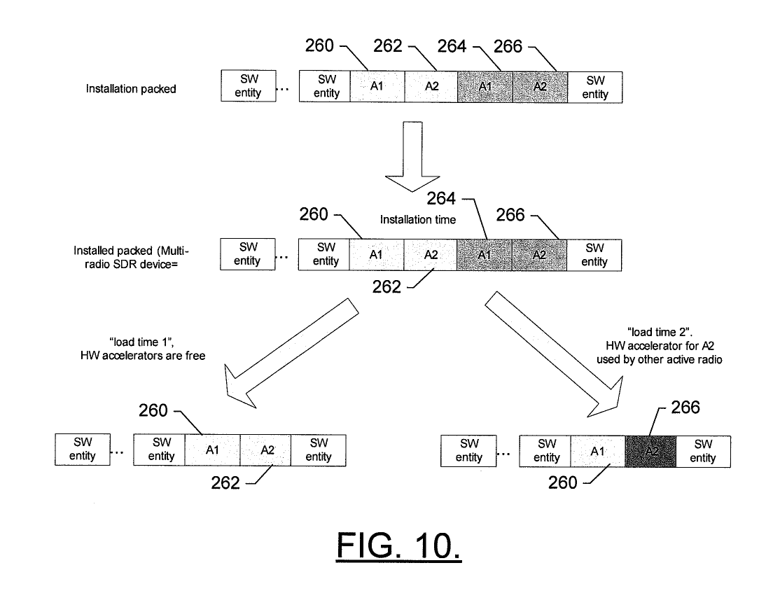

FIG. 10 illustrates how an example embodiment may be used to build a software package for a multi-radio SDR (software defined radio) device. While the device may have accelerators for both functions A1 and A2, the accelerators may not always be available because some other active radio may use them at any given time. Accordingly, both hardware accelerated versions (e.g., elements 260 and 262) and software versions (e.g., elements 264 and 266) of the same function may be installed to enable either to be used based on the availability of the corresponding accelerators. When the radio is activated at “load time 1” when there are no other radios actively using the hardware accelerators, accelerated versions of both functions A1 and A2 (e.g., elements 260 and 262, respectively) may be loaded. At “load time 2”, some other radio may be using the hardware accelerator for A2. Therefore, the software implementation of A2 (element 266) without utilizing hardware accelerators may be loaded, which allows the radio to work by using, for example, a vector processor or signal processor to perform the computations associated with A2. Although use of the accelerator may be more power efficient in some cases, by using the software implementation without use of the accelerator, the SDR may be enabled to run both radios.

Accordingly, some embodiments of the present invention may enable the provision of portability of accelerated or partially accelerated signal processing algorithms by providing an ability to selectively support either hardware accelerated or processor-based implementations dependent upon the target hardware platform that is ultimately to execute code that is being compiled on another platform ahead of time. Thus, different hardware platforms can be supported with efficient use of parallelism by providing flexibility with respect to implementation of hardware accelerated parts.

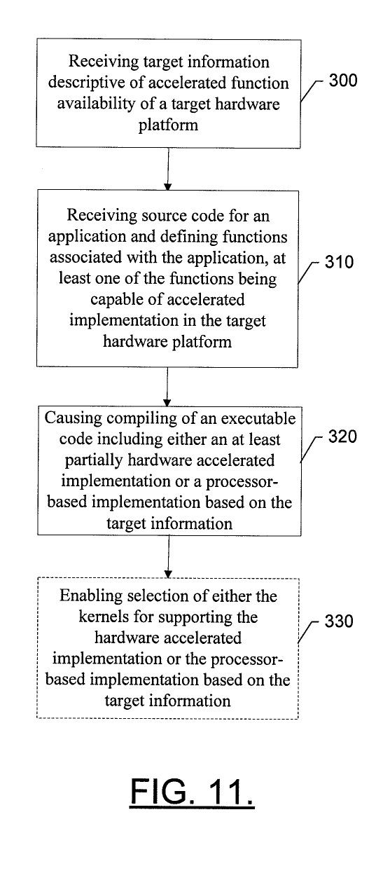

FIG. 11 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or network device and executed by a processor in the user terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 11, may include receiving target information descriptive of accelerated function availability of a target hardware platform at operation 300 and receiving source code for an application and defining functions associated with the application at operation 310. At least one of the functions may be capable of accelerated implementation in the target hardware platform. The method may further include causing compiling of an executable code including either an at least partially hardware accelerated implementation or a processor-based implementation based on the target information at operation 320.

In some embodiments, certain ones of the operations above may be modified or further amplified as described below. Moreover, in some embodiments additional optional operations may also be included (an example of which is shown in dashed lines in FIG. 11). It should be appreciated that each of the modifications, optional additions or amplifications below may be included with the operations above either alone or in combination with any others among the features described herein. In some embodiments, receiving target information may include receiving dynamic information regarding current availability of a particular hardware accelerator in the target hardware platform or receiving static information regarding existence of a hardware accelerator for a particular function in the target hardware platform. In an example embodiment, receiving the source code may include receiving source code provided in a high-level functional language that is also used to define a library of functions that are candidates for acceleration. In some cases, receiving target information may include receiving information generated by a system designer to define which functions are capable of acceleration and wherein receiving the source code comprises receiving the source code from an application developer. In an example embodiment, causing compiling of the executable code may include providing alternative versions of kernels for supporting both hardware accelerated implementation and processor-based implementation. In such an embodiment, in some cases, the method may further include enabling selection of either the kernels for supporting the hardware accelerated implementation or the processor-based implementation based on the target information at operation 330. In some embodiments, causing compiling of the executable code may include providing a selected one of a version of a kernel for supporting hardware accelerated implementation or a version of a kernel for supporting processor-based implementation based on the target information.

In an example embodiment, an apparatus for performing the method of FIG. 11 above may comprise a processor (e.g., the processor 70) configured to perform some or each of the operations (300-330) described above. The processor may, for example, be configured to perform the operations (300-330) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-330 may comprise, for example, the compiler 80. Additionally or alternatively, at least by virtue of the fact that the processor 70 may be configured to control or even be embodied as the compiler 80, the processor 70 and/or a device or circuitry for executing instructions or executing an algorithm for processing information as described above may also form example means for performing operations 300-330.

In some cases, the operations (300-330) described above, along with any of the modifications may be implemented in a method that involves facilitating access to at least one interface to allow access to at least one service via at least one network. In such cases, the at least one service may be said to perform at least operations 300 to 330.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving target information descriptive of accelerated function availability of a target hardware platform;
receiving source code for an application and defining functions associated with the application, at least one of the functions being capable of accelerated implementation in the target hardware platform; and
causing compiling of an executable code including either an at least partially hardware accelerated implementation or a processor-based implementation based on the target information.

2. The method of claim 1, wherein receiving target information comprises receiving dynamic information regarding current availability of a particular hardware accelerator in the target hardware platform.

3. The method of claim 1, wherein receiving target information comprises receiving static information regarding existence of a hardware accelerator for a particular function in the target hardware platform.

4. The method of claim 1, wherein receiving the source code comprises receiving source code provided in a high-level functional language that is also used to define a library of functions that are candidates for acceleration.

5. The method of claim 1, wherein receiving target information comprises receiving information generated by a system designer to define which functions are capable of acceleration and wherein receiving the source code comprises receiving the source code from an application developer.

6. The method of claim 1, wherein causing compiling of the executable code comprises providing alternative versions of kernels for supporting both the at least partially hardware accelerated implementation and processor-based implementation.

7. The method of claim 6, further comprising enabling selection of either the kernels for supporting the at least partially hardware accelerated implementation or the processor-based implementation based on the target information.

8. The method of claim 1, wherein causing compiling of the executable code comprises providing a selected one of a version of a kernel for supporting at least partially hardware accelerated implementation or a version of a kernel for supporting processor-based implementation based on the target information.

9. An apparatus comprising at least one processor and at least one memory including computer program code, the at least one memory and the computer program code configured to, with the at least one processor, cause the apparatus at least to:
receive target information descriptive of accelerated function availability of a target hardware platform;
receive source code for an application and defining functions associated with the application, at least one of the functions being capable of accelerated implementation in the target hardware platform; and
cause compiling of an executable code including either an at least partially hardware accelerated implementation or a processor-based implementation based on the target information.

10. The apparatus of claim 9, wherein the at least one memory and computer program code are configured to, with the at least one processor, cause the apparatus to receive target information by receiving dynamic information regarding current availability of a particular hardware accelerator in the target hardware platform.

11. The apparatus of claim 9, wherein the at least one memory and computer program code are configured to, with the at least one processor, cause the apparatus to receive target information by receiving static information regarding existence of a hardware accelerator for a particular function in the target hardware platform.

12. The apparatus of claim 9, wherein the at least one memory and computer program code are configured to, with the at least one processor, cause the apparatus to receive the source code by receiving source code provided in a high-level functional language that is also used to define a library of functions that are candidates for acceleration.

13. The apparatus of claim 9, wherein the at least one memory and computer program code are configured to, with the at least one processor, cause the apparatus to receive target information by receiving information generated by a system designer to define which functions are capable of acceleration and wherein receiving the source code comprises receiving the source code from an application developer.

14. The apparatus of claim 9, wherein the at least one memory and computer program code are configured to, with the at least one processor, cause the apparatus to cause compiling of the executable code by providing alternative versions of kernels for supporting both at least partially hardware accelerated implementation and processor-based implementation.

15. The apparatus of claim 14, wherein the at least one memory and computer program code are further configured to, with the at least one processor, cause the apparatus to enable selection of either the kernels for supporting the at least partially hardware accelerated implementation or the processor-based implementation based on the target information.

16. The apparatus of claim 9, wherein the at least one memory and computer program code are configured to, with the at least one processor, cause the apparatus to cause compiling of the executable code by providing a selected one of a version of a kernel for supporting at least partially hardware accelerated implementation or a version of a kernel for supporting processor-based implementation based on the target information.

17. The apparatus of claim 9, wherein the apparatus is a mobile terminal and further comprises user interface circuitry configured to facilitate user control of at least some functions of the mobile terminal.

18. A computer program product comprising at least one computer-readable storage medium having computer-executable program code instructions stored therein, the computer-executable program code instructions including program code instructions that when executed at least cause an apparatus to:
receive target information descriptive of accelerated function availability of a target hardware platform;
receive source code for an application and defining functions associated with the application, at least one of the functions being capable of accelerated implementation in the target hardware platform; and
cause compiling of an executable code including either an at least partially hardware accelerated implementation or a processor-based implementation based on the target information.

19. The computer program product of claim 18, wherein program code instructions for receiving target information include instructions for receiving dynamic information regarding current availability of a particular hardware accelerator in the target hardware platform or static information regarding existence of a hardware accelerator for a particular function in the target hardware platform.

20. The computer program product of claim 18, wherein program code instructions for causing compiling of the executable code include instructions for providing a selected one of a version of a kernel for supporting hardware accelerated implementation or a version of a kernel for supporting processor-based implementation based on the target information.
